(19) United States
(12) Patent Application Publication
(10) Pub. No.: US 2024/0182306 A1
(43) Pub. Date: Jun. 6, 2024

(54) Method for Producing a Carbon Material, Carbon Material, and Use of a Carbon Material in a Fuel Cell

(71) Applicant: Bayerische Motoren Werke Aktiengesellschaft, Muenchen (DE)

(72) Inventors: Alin ORFANIDI, Muenchen (DE); Sebastian OTT, Konstanz (DE); Peter STRASSER, Berlin (DE)

(21) Appl. No.: 18/286,177

(22) PCT Filed: Mar. 8, 2022
(86) PCT No.: PCT/EP2022/055905

§ 371 Date: Oct. 9, 2023

(30) Foreign Application Priority Data
Apr. 12, 2021 (DE) 10 2021 108 985.9

(51) Int. Cl. C01B 32/05; H01M 4/86

(52) U.S. Cl. CPC C01B 32/05; H01M 4/8605; H01M 4/8657; C01P 2006/12

(57) ABSTRACT

A method for producing a nitrogen-modified mesoporous and dendritic carbon material includes preparing a carbon precursor comprising a metal acetylide. The carbon precursor is mixed with a nitrogen precursor to form a starter mixture. Thereafter, a first heat treatment of the starter mixture is carried out at a temperature in the range of 40 to 80° C. under vacuum to form a metal inclusion compound. In a next step, a second heat treatment is carried out at a temperature in the range of 120 to 220° C. to produce an intermediate by decomposing the metal inclusion compound under a vacuum. The intermediate is treated to remove the metal, and finally consolidation of the treated intermediate is carried out by a third heat treatment at a temperature in the range of 200 to 1000° C. under vacuum or in an inert gas atmosphere to obtain the nitrogen-modified mesoporous and dendritic carbon material. Also described is a nitrogen-modified mesoporous and dendritic carbon material and a fuel cell comprising the carbon material.

### BACKGROUND AND SUMMARY

The invention relates to a process for producing a nitrogen-modified mesoporous and dendritic carbon material, to a carbon material obtainable by the process, and to the use of such a carbon material as a catalyst support in a fuel cell.

Fuel cells are systems for generation of energy that can generate electrical energy especially by electrochemical conversion of hydrogen and oxygen. A fuel cell in most cases comprises a multitude of single cells, each of which comprises an anode, a cathode, and a membrane disposed between these electrodes. The anode and cathode comprise a catalytically active material, especially platinum or a platinum alloy, which has been applied to a porous support material, especially porous carbon materials having a high specific surface area, and is especially present in the pores of the carbon materials. In addition, an ionomer is typically used as a binder and proton conductor in the anode and cathode.

It has been found that the size of the pores in the support material, especially the pore diameter, is one of the main parameters influencing the mass transfer resistance of the electrodes and hence constitutes a determining factor for the achievable performance of the fuel cell. In known carbon materials having high specific surface area of 500 m²/g or more, the majority of the pores typically have a diameter below 2.0 nm, while there is only a small proportion of pores having greater diameter.

US 2020/0044261 A1 discloses a porous carbon material for use as catalyst support in fuel cells, which belongs to the class of so-called mesoporous carbon nanodendrites (also known by the abbreviation “MCND”). Such nanodendrites have a high specific surface area, for example in the range from 400 to 1520 m²/g, and a relatively high proportion of pores having a diameter greater than 2.0 nm.

A further crucial effect on the performance of a fuel cell is the degree of wetting of the catalytically active material with the ionomer; a high degree of wetting may be required in order to prevent limitation of proton conductivity and mass transfer owing to lack of interaction of the ionomer with the catalytically active material. It has been found that the ionomer is not distributed uniformly in known carbon-based support materials.

DE 10 2017 207 730 A1 describes a carbon material for use as catalyst layer in a fuel cell, which has a carbon lattice incorporating nitrogen atoms for improvement of the distribution of the ionomer. In this way, the distribution of the ionomer is improved on the basis of coulombic interactions between nitrogen-based functionalities embedded in the carbon lattice and ionic groups of the ionomer, especially anionic groups such as sulfonic acid groups. The carbon material is produced by oxidizing a graphitized carbon material with nitric acid and then subjecting it to thermal treatment in an ammonia gas stream.

However, nitrogen-modified support materials are not yet obtainable with sufficiently high specific surface areas or are obtainable only by complex synthesis routes, for example, by subsequent surface functionalization.

There is therefore still a need for support materials for use in fuel cells that enable elevated mass transfer, elevated proton conductivity and better performance.

It is therefore an object of this disclosure to specify such a support material and a simple and inexpensive means of providing such a support material. A particular object of this disclosure is that of providing a support material that enables a fuel cell having improved performance.

The object may be achieved in accordance with the disclosure by a process for producing a nitrogen-modified mesoporous and dendritic carbon material, comprising the following steps: firstly, a metal acetylide is prepared as carbon precursor. Then the carbon precursor is mixed with a nitrogen precursor to give a starter mixture. Thereafter, a first heat treatment of the starter mixture is performed at a temperature in the range from 40 to 80° C. under reduced pressure to form a metal inclusion compound. In a next step, a second heat treatment is performed at a temperature in the range from 120 to 220° C. to produce an intermediate with breakdown of the metal inclusion compound under the reduced pressure. The intermediate is treated to remove the metal and, finally, a consolidation of the treated intermediate is conducted by a third heat treatment at a temperature in the range from 200 to 1000° C. under the reduced pressure or in an inert gas atmosphere to obtain the nitrogen-modified mesoporous and dendritic carbon material.

The process of the disclosure makes it possible for the first time to produce a nitrogen-modified mesoporous and dendritic carbon material that may simultaneously have a high specific surface area, a high proportion of pores having a pore diameter of more than 2.0 nm, and a carbon lattice in which some of the carbon atoms are replaced by nitrogen.

In particular, the process of the disclosure can be performed as a one-pot synthesis, which means that the complexity and costs for production of the carbon material can be kept low. In particular, this constitutes a simplification by comparison with the subsequent modification of a carbon support with nitrogen-containing functional groups, such that a less time-consuming production of the carbon material can be conducted. The incorporation of the nitrogen into the carbon lattice additionally increases the stability of the nitrogen functionalization by comparison with nitrogen groups that have been created merely by surface modification.

The metal acetylide is preferably selected from the group consisting of silver acetylide, copper acetylide and combinations thereof. The metal acetylide is preferably silver acetylide.

The nitrogen precursor may be selected from the group consisting of urea, cyanamide, melamine and combinations thereof. In other words, a solid nitrogen precursor in particular may be used, which simplifies handling.

The carbon precursor and/or nitrogen precursor, prior to the mixing to give a starter mixture, may be dissolved or slurried in a solvent or moistened with a solvent, for which the same solvent or a different solvent may be used for the two precursors. The solvent is preferably an alcohol having one to four carbon atoms, more preferably methanol.

In the starter mixture, in particular, a molar nitrogen to carbon ratio in the range from 0.05 to 1.5 is established, preferably in the range from 0.1 to 1.0, more preferably in the range from 0.3 to 0.92.

The molar nitrogen to carbon ratio in the starter mixture can be used to define the proportion of nitrogen incorporated in the carbon lattice of the carbon material produced by the process of the disclosure. In the case of a molar ratio of nitrogen to carbon of less than 0.05, the result may be a carbon material having too low a proportion of nitrogen, and so no improvement can be expected with regard to wetting with an ionomer. In the case of a molar ratio of nitrogen to carbon of more than 0.92, the carbon material may have a reduced specific surface area and/or lower stability. Moreover, in the case of a molar ratio of nitrogen to carbon of more than 0.92, no further improvement in the advantages caused by the nitrogen may be expected.

The first heat treatment of the starter mixture to form the metal inclusion compound is especially a drying step in order to remove solvent present from the starter mixture.

At the same time, the first heat treatment forms a metal inclusion compound which is used as reactive species in the second heat treatment that follows.

The forming of a metal inclusion compound as starting point for the creation of a mesoporous and dendritic structure is fundamentally known from US 2020/0044261 A1.

The first heat treatment is conducted at a temperature in the range from 40 to 80° C. At a lower temperature, the yield in the formation of the metal inclusion compound may at least be reduced, and a higher temperature may result in excessively rapid conversion of the starter mixture, which may mean that the desired structure of the carbon material is not obtained.

The first heat treatment is especially effected for a period of 12 to 24 hours, preferably of 14 to 22 hours, more preferably of 18 to 20 hours.

In particular, the second heat treatment immediately follows the first heat treatment.

In the second heat treatment, the underlying carbon lattice of the later carbon material forms in the intermediate, in which the carbon atoms are partly replaced by nitrogen atoms. The metal from the carbon precursor especially forms metal nanoparticles on which the carbon lattice is formed.

The breakdown of the metal inclusion compound takes place as a spontaneous and explosive reaction, as a result of which the metal nanoparticles formed can be at least partly converted to metal aggregates.

The second heat treatment is especially effected for a period of 10 to 20 minutes, preferably of 12 to 18 minutes, more preferably of 14 to 16 minutes.

The treatment of the intermediate to remove the metal preferably takes place by washing with a concentrated acid, preferably with concentrated nitric acid or concentrated sulfuric acid. It is fundamentally possible to use any oxidizing acid that does not break down the carbon skeleton of the intermediate.

The term “metal” in association with the first and second heat treatments and the treatment of the intermediate refers here to any form of the metal originating from the carbon precursor, and also includes nanoparticles, aggregates, oxides and other metal compounds that can especially form in the first and second heat treatments.

The treated intermediate, apart from unavoidable impurities, is in particular free of metal.

The treatment of the intermediate may be followed by an optional drying step in order to remove the solvents and wash liquids used during the wash operation.

The consolidating of the treated intermediate by performing the third heat treatment serves to form the nitrogen-modified mesoporous and dendritic carbon material from the treated intermediate, where the third heat treatment is used to achieve a desired stability of the carbon material.

The temperature in the third heat treatment is within a range from 200 to 1000° C. The third heat treatment is preferably conducted at a temperature in the range from 600 to 900° C.

This temperature range constitutes a particularly good compromise between achievable stability of the carbon material, which generally increases with higher temperature, and achievable pore size, which generally decreases with higher temperature.

In particular, a temperature used in the process of the disclosure is below the temperatures of a final heat treatment step as described in the prior art, for example in US 2020/0044261 A1. At temperatures above 1000° C., it is to be expected that the nitrogen incorporated into the carbon lattice of the carbon material will be at least partly removed from the carbon lattice by thermal breakdown, such that the desired effect of improved wettability with ionomer can be achieved to a reduced extent at most, if at all.

The third heat treatment is especially effected for a period of 12 to 24 hours, preferably of 14 to 22 hours, more preferably of 18 to 20 hours.

The object of the disclosure is also achieved by a nitrogen-modified mesoporous and dendritic carbon material obtainable by the process described above, wherein the carbon material has a carbon lattice in which some of the carbon atoms have been replaced by nitrogen atoms.

The nitrogen atoms present in the carbon lattice make the carbon material of the disclosure more polar, which achieves improved wettability for ionomers known in the art. Furthermore, the nitrogen atoms present improve proton conductivity of a catalyst layer comprising the carbon material.

Moreover, the nitrogen is embedded stably within the carbon lattice, such that breakdown of nitrogen-containing groups for conditions that occur in operation of a fuel cell can be ruled out or at least reduced, especially by comparison with nitrogen-containing functional groups that can be created by subsequent surface modification of a carbon support.

Preferably, 0.5 to 1.5 percent by weight of the carbon atoms of the carbon lattice have been replaced by nitrogen atoms, preferably 0.5 to 1.2 percent by weight of the carbon atoms of the carbon lattice. In the case of a lower proportion, no sufficient improvement in charge distribution is achieved, whereas higher proportions can result in less stable carbon materials and/or carbon materials having reduced specific surface area.

The proportion of the nitrogen atoms in the carbon lattice can be determined by elemental analysis of the carbon material.

In order to improve the electrical conductivity and stability of the carbon material, the carbon material may be graphitized, meaning that the carbon lattice has mainly sp²-hybridized carbon atoms.

By virtue of the nitrogen atoms in the carbon lattice, it may include pyridine units and/or pyrrole units. Because of their aromatic character, these can be incorporated particularly advantageously into a graphite-based carbon lattice, such that only minor structural distortions of the carbon lattice are to be expected.

The carbon material has a specific surface area S_{BET} in the range from 900 to 3000 m²/g, preferably from 1000 to 2150 m²/g, more preferably from 1300 to 2150 m²/g, determined by the BET method using a nitrogen adsorption isotherm.

In order to enable high mass transfer through the carbon material, the carbon material especially has a Vₘₑₛₒ/Vₜₒₜₐₗ ratio in the range from 0.25 to 0.75, preferably from 0.30 to 0.65, more preferably from 0.35 to 0.6, where Vₘₑₛₒ denotes the volume of all pores of the carbon material of a pore size in the range from 2.5 to 6.0 nm and Vₜₒₜₐₗ the total volume of all pores of the carbon material.

In other words, the carbon material of the invention has a significant proportion of what are called mesopores having a size of 2.5 nm to 6.0 nm, which are particularly advantageous for rapid mass transfer in fuel cell applications.

The present pore sizes and the volume thereof can be determined by a nitrogen adsorption isotherm, especially by numerical analysis of the nitrogen adsorption isotherm using a DFT model (DFT: density-functional theory).

With regard to gas diffusion rate, the carbon material especially has a nitrogen uptake volume V_{N:0.4-0.8} in the range from 80 to 220 cm³ (STP)/g auf, preferably from 100 to 200 cm³ (STP)/g, more preferably from 110 to 190 cm³ (STP)/g, where V_{N:0.4-0.8} denotes the volume of nitrogen in the relative pressure range p/p₀ of 0.4 to 0.8 in the nitrogen adsorption isotherm. A smaller nitrogen uptake volume V_{N:0.4-0.8} would be characteristic of a carbon material having too low a proportion of mesopores, such that insufficient mass transfer in such carbon materials is to be expected. A nitrogen uptake volume V_{N:0.4-0.8} exceeding 220 cm³ (STP)/g would result in a carbon material having too low a mechanical stability.

The abbreviation “STP” stands here for “standard temperature and pressure”, i.e. for a temperature of 0° C. and a pressure of 1 bar.

The carbon material may have a dV_{2.5-6 nm} value in the range from 0.5 to 0.9 cm³/g, preferably from 0.53 to 0.86 cm³/g, more preferably from 0.55 to 0.74 cm³/g, where the dV_{2.5-6 nm} value describes the cumulative volume of the pores having a pore diameter in the range from 2.5 to 6.0 nm based on the unit of weight, obtainable by derivation of the cumulative pore volume based on the pore diameter, followed by integration over the respective pore diameter range.

The object of the disclosure is additionally achieved by the use of the above-described nitrogen-modified mesoporous and dendritic carbon material as catalyst support in a fuel cell.

In the fuel cell, the carbon material is especially used in a catalyst layer of an electrode of the fuel cell, i.e. an anode and/or cathode.

The catalytically active material used in the catalyst layer is especially at least one precious metal which accumulates in the porous structure of the carbon material. The catalytically active material preferably comprises platinum or a platinum alloy, for example a platinum alloy with palladium, cobalt and/or nickel.

The catalyst layer also includes an ionomer as binder. The ionomer is preferably a sulfonic acid-based thermoplastic, for example a perfluorosulfonic acid (PFSA). Such perfluorosulfonic acids are available under the “Nafion” name from DuPont, under the “Aquivion” name from Solvay, or under the “Dyneon” name from 3M or from Asahi Glass. Such ionomers can particularly advantageously interact with the nitrogen in the carbon lattice, so as to result in improved wettability of the carbon material.

Further properties and advantages of the disclosure will be apparent from the description that follows of an illustrative embodiment, and from the examples that should not be understood in a restrictive sense, and from the figures.

### BRIEF DESCRIPTION OF THE FIGURES

The figures show:

FIG. 1: a block diagram of the process of the disclosure for producing a nitrogen-modified mesoporous and dendritic carbon material,

FIG. 2: an SEM image of an intermediate obtained in the process of the disclosure as per FIG. 1,

FIG. 3: a detail of the SEM image from FIG. 2 in greater magnification,

FIG. 4: a TEM image of an intermediate obtained in the process of the disclosure as per FIG. 1,

FIG. 5: the cumulative specific surface area of the carbon materials of examples 1 to 5 as a function of pore diameter,

FIG. 6: the cumulative specific surface area of the carbon materials of examples 6 to 9 as a function of pore diameter,

FIG. 7: the cumulative specific surface area of the carbon materials of examples 10 to 13 as a function of pore diameter,

FIG. 8: the derivative of the pore volume with respect to the pore diameter as a function of pore diameter for examples 1 to 5,

FIG. 9: the derivative of the pore volume with respect to the pore diameter as a function of pore diameter for examples 6 to 9,

FIG. 10: the derivative of the pore volume with respect to the pore diameter as a function of pore diameter for examples 10 to 13,

FIG. 11: the relative weight of the intermediate from examples 1 to 5 as a function of temperature,

FIG. 12: the relative weight of the intermediate from examples 6 and 7 as a function of temperature, and

FIG. 13: the relative weight of the intermediate from examples 10 and 13 as a function of temperature.

### DETAILED DESCRIPTION OF THE FIGURES

A commercially available porous and three-dimensional carbon material from AkzoNobel was used as a comparative example, which is sold under the name “KETJENBLACK EC300j” and is used for fuel cells.

A process of the disclosure is elucidated in detail hereinafter together with examples 2 to 13.

### Step S1: Producing a Metal Acetylide as Carbon Precursor

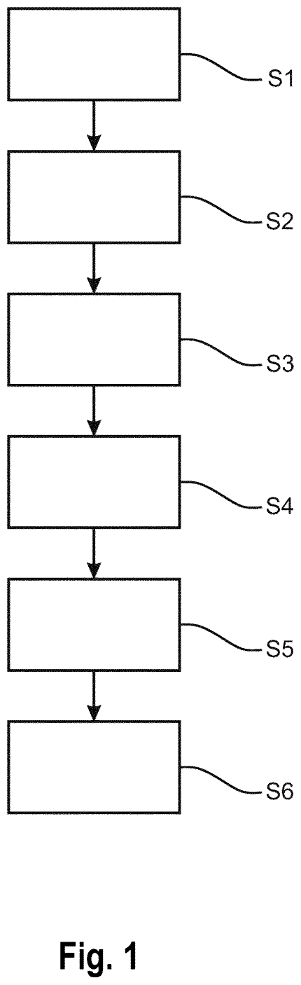

First of all, a metal acetylide is produced as carbon precursor (step S1 in FIG. 1).

For this purpose, an aqueous ammoniacal silver nitrate solution is prepared by adding 20.34 mL of an aqueous ammonia solution (20 percent by weight of ammonia) to 414 mL of an aqueous silver nitrate solution (1.275 mg of silver nitrate), so as to establish a molar ratio of ammonia:silver of about 29:1.

Subsequently, the solution is purged with nitrogen or argon for 10 to 20 minutes in order to displace oxygen present in the solution.

Then gaseous acetylene is passed through the solution for about 5 minutes under treatment with ultrasound until the solution turns yellow.

Subsequently, acetylene is passed through the solution without ultrasound treatment for a further 5 minutes. The solution then turns gray to colourless, with precipitation of a white-grayish solid.

As soon as the solid precipitates out, the acetylene flow is stopped and the precipitate is obtained by filtering the solution through a membrane filter. The precipitate is washed with methanol and filtered again. This keeps the precipitate moist in order to prevent detonation of the precipitate.

Step S2: Mixing the Carbon Precursor with a Nitrogen Precursor to Give a Starter Mixture

The required amount of nitrogen precursor is weighed out and dissolved completely in methanol. The nitrogen precursor solution is initially charged in a Teflon reactor.

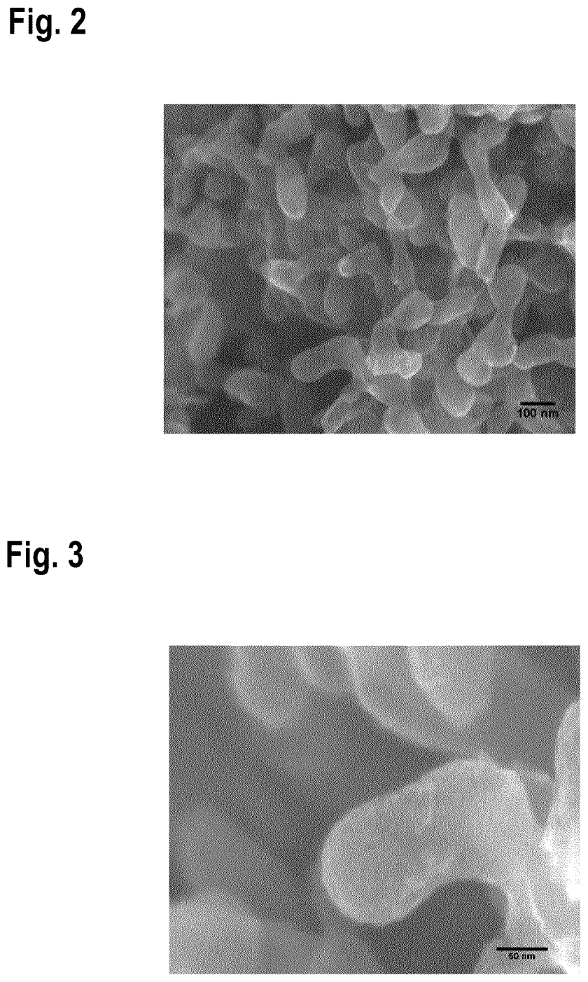

The filtrate of the carbon precursor is then added and hence mixed with the nitrogen precursor (cf. step S2 in FIG. 2).

Table 1 lists the nitrogen precursors used in examples 2 to 13 and the molar ratio of nitrogen to carbon used in the starter mixture.

In all examples, silver acetylide was used as the carbon precursor.

TABLE 1
Overview of examples

| | | | | Temperature |
|---|---|---|---|---|
| | | | | in the |
| | | | Molar | third heat |
| | | Nitrogen | nitrogen:carbon | treatment in |
| Designation | | precursor | ratio | ° C. |
| Example 1* | | — | — | — |
| KETJENBLACK | | | | |
| EC 300j | | | | |
| Example 2 | M2 | cyanamide | 0.0507 | — |
| Example 3 | M3 | cyanamide | 0.0634 | 200 |
| Example 4 | M4 | cyanamide | 0.0951 | 600 |
| Example 5 | M5 | cyanamide | 0.0951 | 900 |
| Example 6 | M6 | melamine | 0.1188 | — |
| Example 7 | M7 | melamine | 0.1585 | 200 |
| Example 8 | M8 | melamine | 0.5071 | 600 |
| Example 9 | M9 | melamine | 0.5071 | 900 |
| Example 10 | M10 | urea | 0.3097 | — |
| Example 11 | M11 | urea | 0.4954 | 200 |
| Example 12 | M12 | urea | 0.6193 | 600 |
| Example 13 | M13 | urea | 0.9290 | 900 |

*comparative example

### Step S3: First Heat Treatment

The Teflon reactor containing silver acetylide as carbon precursor and the particular nitrogen precursor used is placed in a stainless steel cylinder having a diameter of 50 mm and a height of 70 mm, which is closed with a stainless steel lid. The lid has two valves, one of the valves being connected to a vacuum pump and the other of the valves being set up to release the reduced pressure within the stainless steel cylinder and flood it with air. As a safety measure, there is an additional pressure relief valve disposed between the stainless steel cylinder and the valve connected to the vacuum pump.

The stainless steel cylinder is closed tight, and the vacuum pump is switched on in order to dry the starter mixture and to establish an airless atmosphere within the stainless steel cylinder.

The stainless steel cylinder is heated under reduced pressure to a temperature of 80° C. by means of a heating mantle or heating bath overnight for a total of about 20 hours. Alternatively, an oven can also be used for heating.

In this way, the first heat treatment creates a metal inclusion compound in the Teflon reactor (step S3 in FIG. 1).

### Step S4: Second Heat Treatment

Immediately after the first heat treatment, i.e. without removing the metal inclusion compound from the stainless steel cylinder, without removing the stainless steel cylinder from the oven, and still under reduced pressure, a second heat treatment is conducted to produce an intermediate with breakdown of the metal inclusion compound (step S4 in FIG. 1).

For this purpose, the stainless steel cylinder is heated under reduced pressure to a temperature of 220° C. in the oven for 15 minutes.

This heating results in onset of a spontaneous and explosive breakdown reaction of the silver acetylide, which gives the carbon material in the intermediate with a carbon lattice in which some of the carbon atoms have been replaced by nitrogen from the nitrogen precursor.

### Step S5: Treatment of the Intermediate

The intermediate obtained from step S4 is removed from the Teflon reactor and immersed into a 65% solution of concentrated nitric acid at a temperature of 25° C. for 30 minutes.

In this way, silver present in the intermediate and carbon compounds present on the surface of the carbon material are washed out (step S5 in FIG. 1).

Subsequently, the intermediate is washed with water in order to remove all traces of nitric acid and further silver.

Finally, the intermediate thus treated is dried at 80° C. under reduced pressure for at least 12 hours.

For all of examples 2 to 13, the same residence time in the nitric acid and the same drying time were used.

FIGS. 2 and 3 show SEM images of the intermediate from example 2 after step S5, i.e. after the wash with nitric acid; FIG. 3 shows a detail from FIG. 2 with greater magnification.

The three-dimensional mesoporous and dendritic structure created in the intermediate is clearly apparent from these images. It should be noted that, because of the available resolution in FIGS. 2 and 3, what can be seen are essentially what are called primary aggregates composed of primary particles, and secondary agglomerates comprising a multitude of primary aggregates.

The primary particles themselves have the desired mesopores having a pore diameter in the range from 2.5 to 6.0 nm, which are of crucial significance for later use as catalyst support in fuel cells.

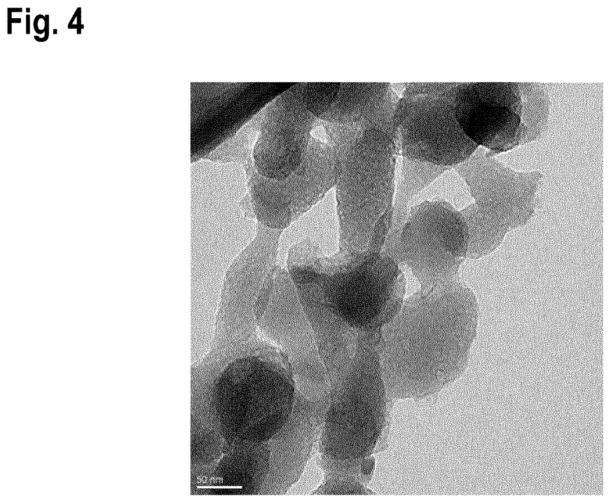

The porous structure of the primary aggregates is illustrated by the TEM image of the intermediate from Example 2 shown in FIG. 4.

### Step S6: Consolidating the Intermediate/Third Heat Treatment

The washed intermediate is transferred into a tubular furnace and purged with argon for at least 10 minutes.

Subsequently, the intermediate is heated in an inert gas atmosphere using argon as inert gas for 20 hours, using the temperature listed in Table 1 for each of examples 2 to 13 (step S6 in FIG. 1).

A heating rate of 400 K/h is used for heating and an argon flow rate of 50 mL/min to maintain the inert gas atmosphere.

A nitrogen-modified mesoporous and dendritic carbon material is obtained. Tables 2 and 3 show the properties of the carbon materials obtained in examples 2 to 13 and of comparative example 1.

TABLE 2
Properties of the carbon materials

| | Proportion of | | | | |
|---|---|---|---|---|---|
| | nitrogen in | | | | |
| | the carbon | | | dV_{2.5-6 nm} | V_{N: 0.4-0.8} |
| | lattice (% by | S_{BET} in | Vₘₑₛₒ/ | in | in |
| Designation | wt.) | m²/g | Vₜₒₜₐₗ | cm³/g | cm³(STP)/g |
| Example 1* | 0 | 843 | 0.22 | 0.29 | 135 |
| Example 2 | 0.68 | 1730 | 0.55 | 0.73 | 169 |
| Example 3 | 0.33 | 1519 | 0.42 | 0.53 | 131 |
| Example 4 | 0.71 | 2101 | 0.54 | 0.86 | 184 |
| Example 5 | 0.72 | 1689 | 0.40 | 0.53 | 144 |
| Example 6 | 1.07 | 1634 | 0.39 | 0.51 | 127 |
| Example 7 | 0.89 | 1706 | 0.37 | 0.55 | 145 |
| Example 8 | 1.1 | 1517 | 0.48 | 0.59 | 133 |
| Example 9 | 0.11 | 1679 | 0.49 | 0.64 | 147 |
| Example 10 | 1 | 1777 | 0.50 | 0.66 | 148 |
| Example 11 | 1.47 | 1754 | 0.54 | 0.74 | 171 |
| Example 12 | 1.33 | 1816 | 0.46 | 0.67 | 173 |
| Example 13 | 0.85 | 1916 | 0.47 | 0.67 | 147 |

*comparative example

### Elemental Analysis

The proportion of nitrogen in the carbon lattice of the carbon material was determined by elemental analysis. For this purpose, a Thermo Flash 1112 elemental analyzer from THERMO FINNIGAN was used to determine the proportions of carbon, hydrogen, nitrogen and sulfur.

The samples were burnt in the presence of V₂O₅ as oxidizing agent at a combustion temperature of 1020° C. by dynamic flash combustion (modified Dumas method). The breakdown took place in a manually layered reactor having WO₃/Cu/Al₂O₃ layers. The gases formed were determined and quantified by gas chromatography (GC).

### Microstructure Analysis

In order to examine the micro- and mesoporous structure of the samples and to determine the specific surface area, nitrogen isotherms (physisorption isotherms) were determined at a temperature of 77 K by means of an “Autosorb-1” analysis instrument from QUANTACHROME.

The samples were each transferred into a glass tube having a diameter of 4 mm, which had additionally been filled with layers of glass wool and a glass rod in order to minimize the dead volume.

The mass of sample was chosen so as to achieve an absolute surface area of more than 10 m², in order to reduce measurement errors.

The samples were degassed at 90° C. under reduced pressure for at least 24 hours in order to remove any adsorbent present, for example water or gas, before the measurement. The degassing temperature chosen was no higher in order to avoid breakdown of the nitrogen-containing groups of the carbon material.

The adsorption isotherms and the desorption isotherms of the nitrogen isotherms were recorded in the range of 10⁻⁵≤ p/p₀≤ 0.995, where p₀ indicates the saturation pressure and p the actual gas pressure.

The specific surface area S_{BET} was determined by the BET method.

The V_{N:0.4-0.8} value indicates the difference in volume of adsorbed nitrogen at a p/p₀ value of 0.8 and at a p/p₀ value of 0.4 in cm³ (STP)/g or cc (STP)/g.

The characterization of the micro- and mesopores present was undertaken by numerical analysis using a DFT model, using the QSDFT kernel (QSDFT: Quenched Solid Density Functional Theory) with a model for slot-shaped (diameter <2 nm) and cylindrical pores (diameter >2 nm), based on the adsorption branch of the nitrogen isotherms.

Using the numerical analysis, the volume Vₘₑₛₒ of all pores having a diameter in the range from 2.5 to 6.0 nm and the total volume Vₜₒₜₐₗ of all pores were ascertained.

The derivative of pore volume with respect to diameter, dV(d), was calculated using the values obtained from the QSDFT analysis.

It becomes clear from Table 2 that the carbon materials obtainable by the process of the disclosure have a high specific surface area S_{BET}, especially a specific surface area several times higher than comparative example 1.

It also becomes clear from the Vₘₑₛₒ/Vₜₒₜₐₗ ratio ascertained for the examples that the carbon materials obtainable by the process of the invention have a high proportion of mesopores having a pore diameter in the range from 2.5 to 6.0 nm.

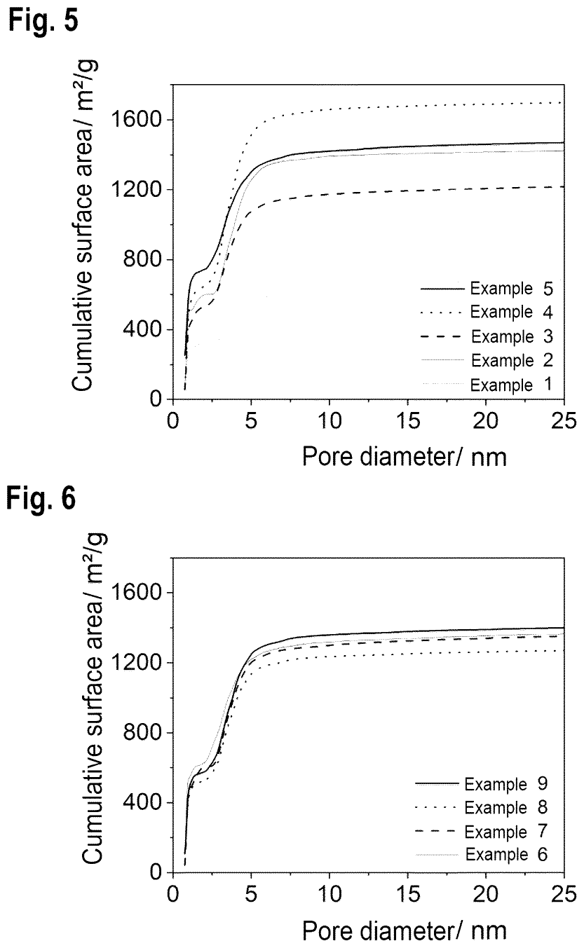

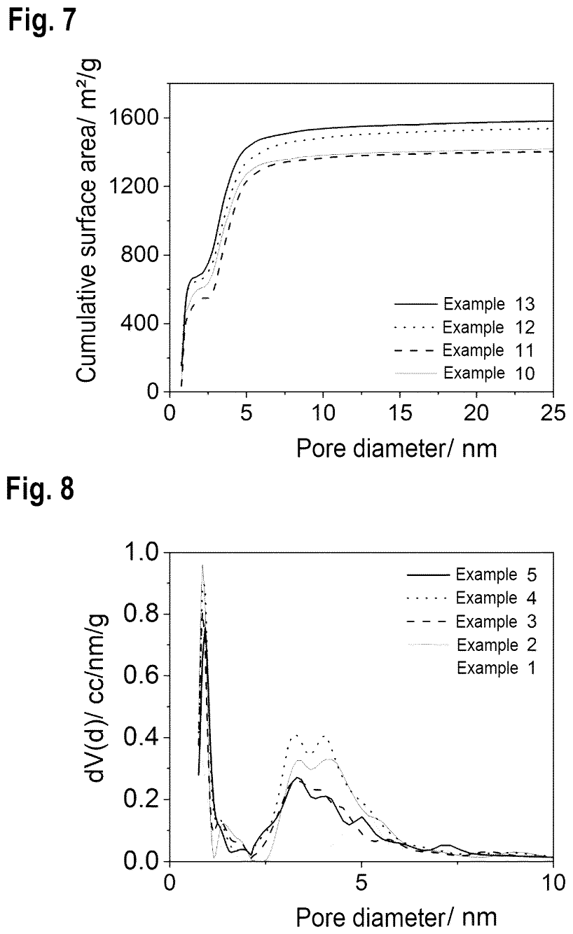

This is also apparent from the plots shown in FIGS. 5 to 7, which indicate the cumulative specific surface area as a function of pore diameter. It is apparent that a significant proportion of the specific surface area S_{BET} is generated by pores having a pore diameter in the range from 2.5 to 6.0 nm.

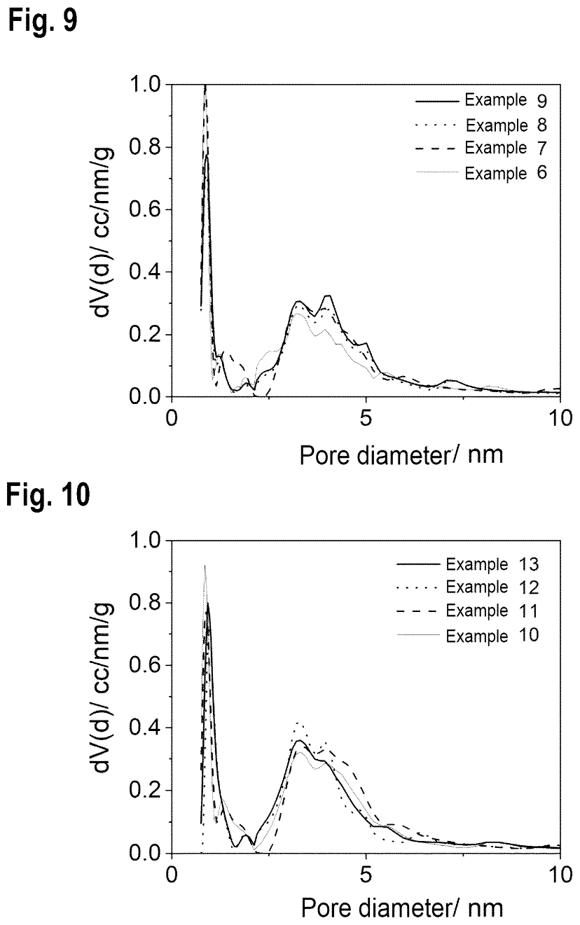

FIGS. 8 to 10 show the derivative of volume with respect to pore diameter as a function of pore diameter. The pore size distribution is particularly clear in this diagram. In particular, it is apparent that there is a narrow distribution of pores having a very small diameter in all examples. In addition, however, the carbon materials obtainable by the process of the invention have a significant proportion of pores having a pore diameter in the range from 2.5 to 6.0 nm, especially a greater proportion than is the case for comparative example 1 (cf. FIG. 8).

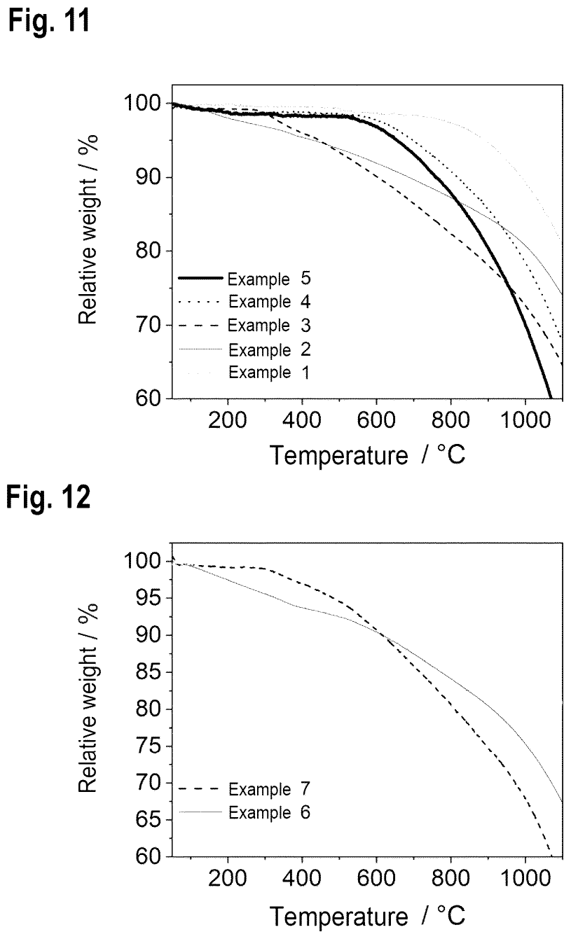

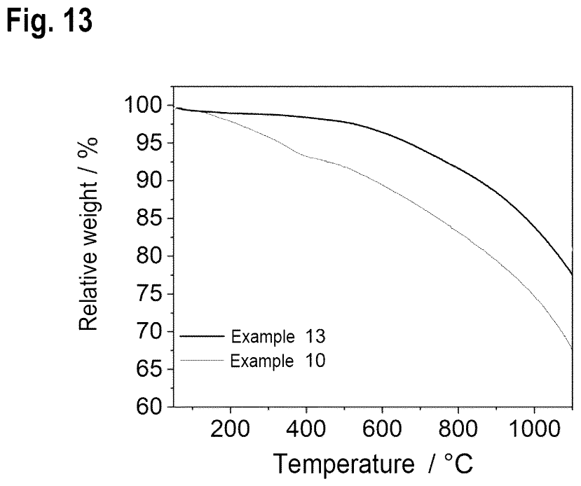

FIGS. 11 to 13 show the relative weight of the intermediate from examples 1 to 5, 6 and 7 and 10 and 13 as a function of temperature, as determined by thermogravimetry analysis by means of a STA-8000 from PerkinElmer. For the thermogravimetry analysis, a ceramic crucible was charged with the sample to be analyzed and the loss of mass was recorded at a heating rate of 5 K/min under argon atmosphere. After calibration at a gas pressure of 1.1 bar, the temperature was increased within a temperature range from 23 to 1100° C.

The third heat treatment is necessary in order to obtain sufficient stability of the carbon material. In particular, in the third heat treatment, organic residues that have an adverse effect on the performance of the carbon material of the invention are removed from the intermediate. At the same time, however, increasing degradation of the carbon material also takes place at high temperatures, and so a temperature of 1000° C. in the third heat treatment step should not be exceeded.

Thus, by means of the process of the disclosure, carbon materials that are firstly nitrogen-modified, and in this way show improved interaction with ionomers, and secondly have a mesoporous and dendritic structure with high surface area are producible in a simple manner, such that mass transfer in fuel cell applications is promoted, combined with a high specific surface area for high performance in such applications.

1-11. (canceled)

12. A process for producing a nitrogen-modified mesoporous and dendritic carbon material, the process comprising:
preparing a carbon precursor comprising a metal acetylide;
mixing the carbon precursor with a nitrogen precursor to form a starter mixture;
performing a first heat treatment of the starter mixture at a temperature in a range from 40 to 80° C. under reduced pressure to form a metal inclusion compound;
performing a second heat treatment at a temperature in the range from 120 to 220° C. to break down the metal inclusion compound under the reduced pressure and produce an intermediate comprising a metal, the intermediate having a carbon lattice in which some carbon atoms are replaced by nitrogen atoms;
treating the intermediate to remove the metal and form a treated intermediate, and
consolidating the treated intermediate by performing a third heat treatment at a temperature in the range from 200 to 1000° C. under reduced pressure or in an inert gas atmosphere to obtain the nitrogen-modified mesoporous and dendritic carbon material.

13. The process according to claim 12, wherein the nitrogen precursor is selected from the group consisting of urea, cyanamide, melamine, and combinations thereof.

14. The process according to claim 12, wherein a molar ratio of nitrogen to carbon in the range from 0.05 to 1.5 is established in the starter mixture.

15. The process according to claim 14, wherein the molar ratio is in the range from 0.1 to 1.0.

16. The process according to claim 15, wherein the molar ratio is in the range from 0.3 to 0.92.

17. The process according to claim 12, wherein the third heat treatment is conducted at a temperature in the range from 600 to 900° C.

18. A nitrogen-modified mesoporous and dendritic carbon material formed by the process according to claim 12, wherein
the carbon material has the carbon lattice in which some of the carbon atoms are replaced by nitrogen atoms, and
the carbon material has a specific surface area in a range from 900 to 3000 m²/g determined by a BET method using a nitrogen adsorption isotherm.

19. The carbon material according to claim 18, wherein 0.5 to 1.5 percent by weight of the carbon atoms in the carbon lattice have been replaced by nitrogen atoms.

20. The carbon material according to claim 18, wherein the specific surface area is in the range from 1000 to 2150 m²/g.

21. The carbon material according to claim 20, wherein the specific surface area is in the range from 1300 to 2150 m²/g.

22. The carbon material according to claim 18, wherein the carbon material has a Vₘₑₛₒ/Vₜₒₜₐₗ ratio in the range from 0.25 to 0.75, wherein Vₘₑₛₒ denotes a volume of all pores of the carbon material of a pore size in the range from 2.5 to 6.0 nm and Vₜₒₜₐₗ denotes a total volume of all pores of the carbon material.

23. The carbon material according to claim 22, wherein the Vₘₑₛₒ/Vₜₒₜₐₗ ratio is in the range from 0.30 to 0.65.

24. The carbon material according to claim 23, wherein the Vₘₑₛₒ/Vₜₒₜₐₗ ratio is in the range from 0.30 to 0.6.

25. The carbon material according to claim 18, wherein the carbon material has a nitrogen uptake volume V_{N:0.4-0.8} in the range from 80 to 220 cm³ (STP)/g, where V_{N:0.4-0.8} denotes volume of nitrogen in a relative pressure range p/p₀ from 0.4 to 0.8 of a nitrogen adsorption isotherm.

26. The carbon material according to claim 25, wherein the nitrogen uptake volume V_{N:0.4-0.8} is in the range from 100 to 200 cm³ (STP)/g.

27. The carbon material according to claim 26, wherein the nitrogen uptake volume V_{N:0.4-0.8} is in the range from 110 to 190 cm³ (STP)/g.

28. The carbon material according to claim 18, wherein the carbon material has a dV_{2.5-6 nm} value in a range from 0.5 to 0.9 cm³/g, where the dV_{2.5-6 nm} value describes a cumulative volume of pores having a pore diameter in a range from 2.5 to 6.0 nm based on a unit of weight, obtainable by derivation of cumulative pore volume based on pore diameter, followed by integration over respective pore diameter range.

29. The carbon material according to claim 28, wherein the dV_{2.5-6 nm} value is in the range from 0.53 to 0.86 cm³/g.

30. The carbon material according to claim 29, wherein the dV_{2.5-6 nm} value is in the range from 0.55 to 0.574 cm³/g.

31. A fuel cell comprising the nitrogen-modified mesoporous and dendritic carbon material according to claim 18.
